(19) United States
(12) Patent Application Publication
(10) Pub. No.: US 2014/0234699 A1
(43) Pub. Date: Aug. 21, 2014

(54) ANODE MATERIALS FOR MAGNESIUM ION BATTERIES

(71) Applicant: Toyota Motor Engineering & Manufacturing North America, Inc., (US)

(72) Inventors: Chen Ling, Ann Arbor, MI (US); Nikhilendra Singh, Ypsilanti, MI (US); Masaki Matsui, Tsu (JP); Fuminori Mizuno, Ann Arbor, MI (US)

(73) Assignee: Toyota Motor Engineering & Manufacturing North America, Inc., Erlanger, KY (US)

(21) Appl. No.: 13/770,581

(22) Filed: Feb. 19, 2013

(51) Int. Cl. H01M 4/36

(52) U.S. Cl. CPC H01M 4/36
USPC 429/188; 252/182.1

(57) ABSTRACT

A compound of the formula: A_{b}MgₐX₁₋ₐ (0≦a<1, 0≦b≦0.1) for use as an anode material in a magnesium ion battery wherein X is selected from one or more of: group 15 elements, group 14 elements, group 13 elements, transition metals from groups 3-12 and lanthanides. The working voltage of the compound is greater than the voltage of deposition of magnesium.

### FIELD OF THE INVENTION

The invention relates to materials for electrodes for magnesium ion batteries.

### BACKGROUND OF THE INVENTION

Rechargeable batteries, such as lithium-ion batteries, have numerous commercial applications. Energy-density is an important characteristic, and higher energy-densities are desirable for a variety of applications.

A magnesium ion in a magnesium or magnesium ion battery carries two electrical charges, in contrast to the single charge of a lithium ion. Improved electrode materials would be very useful in order to develop high energy-density batteries.

One potential electrode material is pure Magnesium (Mg) which provides the highest energy-density as an Mg battery anode. While Mg would provide the highest energy-density for Mg batteries, it remains incompatible with high voltage conventional battery electrolytes. The use of Mg in such conventional battery electrolytes results in the formation of a Mg²⁺ blocking layer on the Mg metal anode surface.

There is therefore a need in the art for active electrode materials for magnesium batteries that allow insertion of magnesium ions utilizing conventional electrolytes without the formation of Mg²⁺ blocking layers. There is also a need in the art for a method of selecting such active materials.

### SUMMARY OF THE INVENTION

In one aspect, there is disclosed, a compound of the formula: A_{b}MgₐX₁₋ₐ (0≦a<1, 0≦b≦0.1) for use as an anode material in a magnesium ion battery wherein X is selected from one or more of: group 15 elements, group 14 elements, group 13 elements, transition metals from groups 3-12 and lanthanides.

In another aspect, there is disclosed an anode for a magnesium ion battery. The anode includes a compound of the formula: A_{b}MgₐX₁₋ₐ (0≦a<1, 0≦b≦0.1) wherein X is selected from one or more of: group 15 elements, group 14 elements, group 13 elements, transition metals from groups 3-12 and lanthanides.

In a further aspect, there is disclosed an energy-storage device that includes: a first electrode including an active material; a second electrode; an electrolyte disposed between the first electrode and the second electrode, the electrolyte including a magnesium compound, the active material including. a compound of the formula:

A_{b}MgₐX₁₋ₐ (0≦a<1, 0≦b≦0.1) wherein X is selected from one or more of group 15 elements, group 14 elements, group 13 elements, transition metals from groups 3-12 and lanthanides.

### BRIEF DESCRIPTION OF THE DRAWINGS

FIG. 1 is a voltage diagram detailing a plot of the Mg²⁺ insertion voltage as a function of time for La;

FIG. 2 is a voltage diagram detailing a plot of the Mg²⁺ insertion voltage as a function of time for Ni;

FIG. 3 is a voltage diagram detailing a plot of the Mg²⁺ insertion voltage as a function of time for Zn;

FIG. 4 is a voltage diagram detailing a plot of the Mg²⁺ insertion voltage as a function of time for Ag;

FIG. 5 is a voltage diagram detailing a plot of the Mg²⁺ insertion voltage as a function of time for Ge;

FIG. 6 is a voltage diagram detailing a plot of the Mg²⁺ insertion voltage as a function of time for Y;

FIG. 7 is a voltage diagram detailing a plot of the Mg²⁺ insertion voltage as a function of time for Al;

FIG. 8 is a voltage diagram detailing a plot of the Mg²⁺ insertion voltage as a function of time for B;

FIG. 9 is a voltage diagram detailing a plot of the Mg²⁺ insertion voltage as a function of time for Bi;

FIG. 10 is a voltage diagram detailing a plot of the Mg²⁺ insertion voltage as a function of time for Sb

FIG. 11 is a voltage diagram detailing a plot of the Mg²⁺ insertion voltage as a function of time for Sn

FIG. 12 is a voltage diagram detailing a plot of the Mg²⁺ insertion voltage as a function of time for In;

FIG. 13 is a plot of XRD spectra for (1) as-fabricated Sn, (2) magnesiated Sn (or Mg₂Sn—peak positions marked with arrows) and (3) de-magnesiated Mg₂Sn.; and

FIG. 14 is a plot of XRD spectra for 1) In deposited on copper 2) In deposited on platinum coated copper substrate and 3) magnesiated In on a copper substrate.

### DETAILED DESCRIPTION OF THE PREFERRED EMBODIMENTS

In one aspect, there is disclosed, a compound of the formula: A_{b}MgₐX₁₋ₐ (0≦a<1, 0≦b≦0.1) for use as an anode material in a magnesium ion battery wherein X is selected from one or more of: group 15 elements, group 14 elements, group 13 elements, transition metals from groups 3-12 and lanthanides.

In another aspect, there is disclosed an anode for a magnesium ion battery. The anode includes a compound of the formula: A_{b}MgₐX₁₋ₐ (0≦a≦1, 0≦b<0.1) wherein X is selected from one or more of: group 15 elements, group 14 elements, group 13 elements, transition metals from groups 3-12 and lanthanides.

In a further aspect, there is disclosed an energy-storage device that includes a first electrode including an active material; a second electrode; an electrolyte disposed between the first electrode and the second electrode, the electrolyte including a magnesium compound, the active material including, a compound of the formula:

A_{b}MgₐX₁₋ₐ (0≦a<1, 0≦b≦0.1) wherein X is selected from one or more of: group 15 elements, group 14 elements, group 13 elements, transition metals from groups 3-12 and lanthanides.

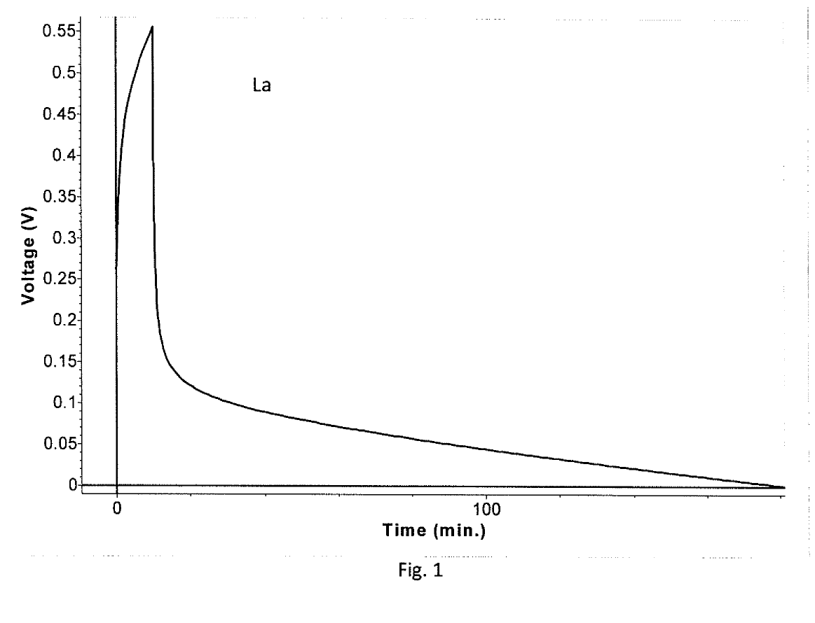

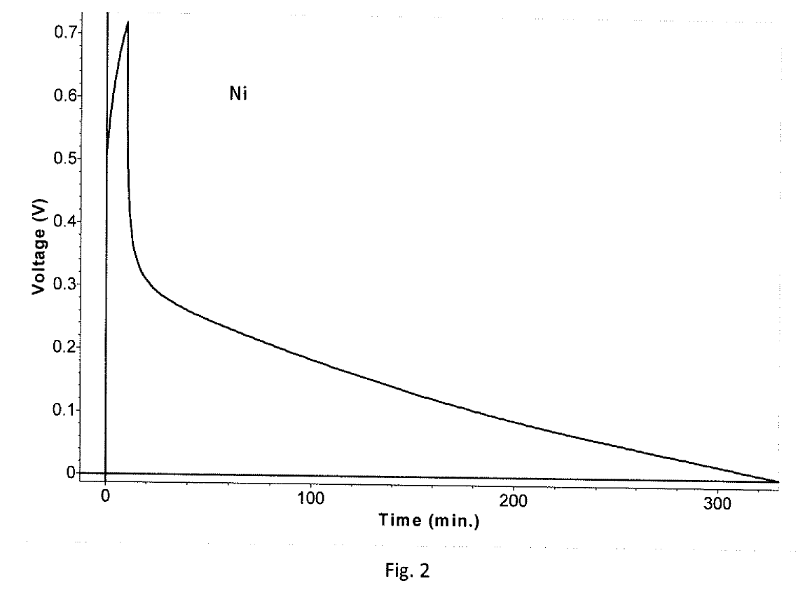

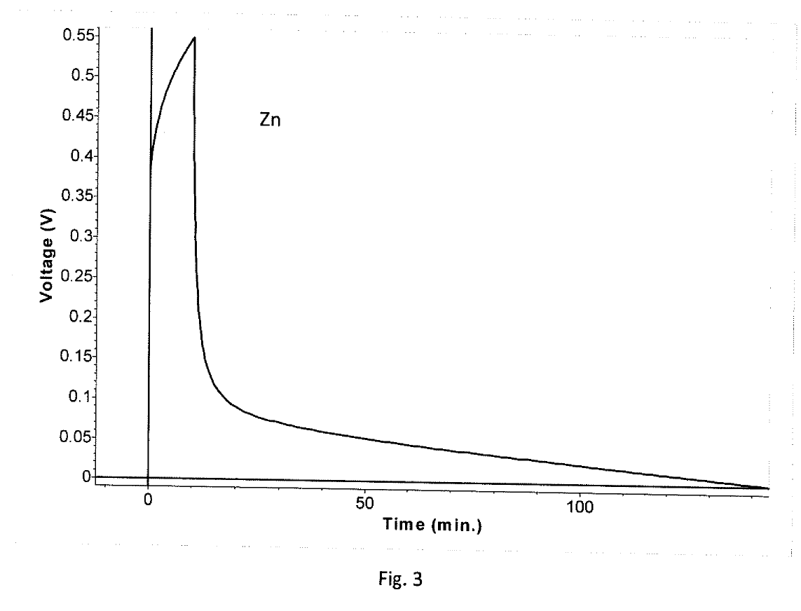

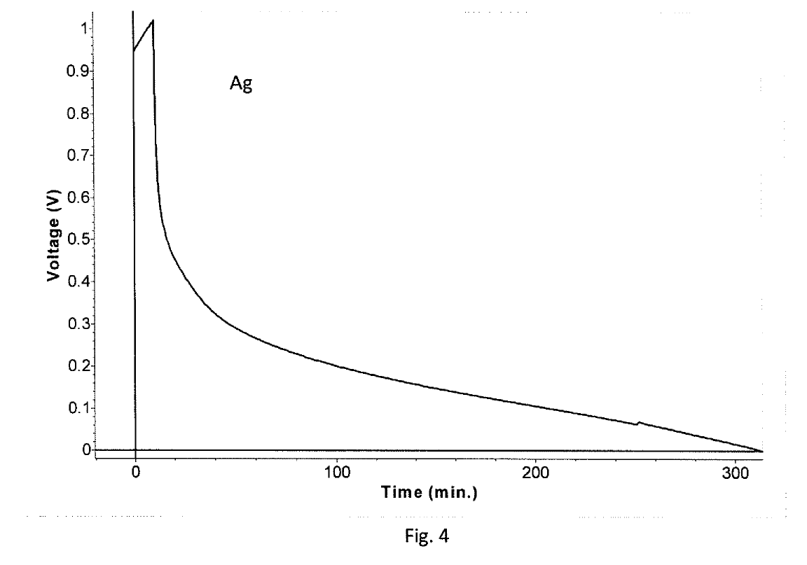

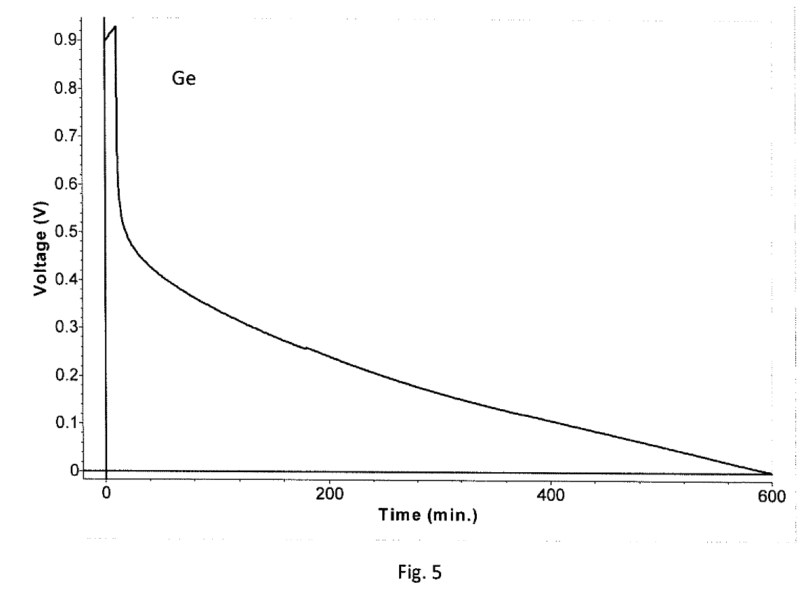

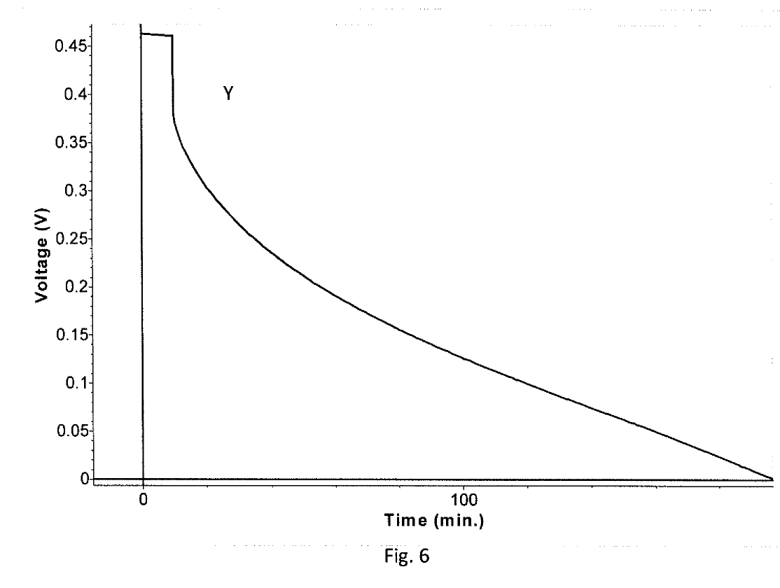

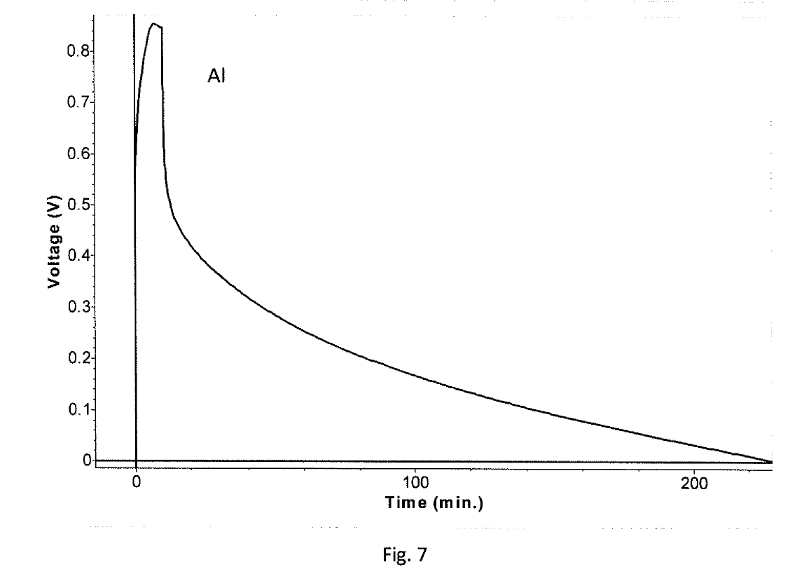

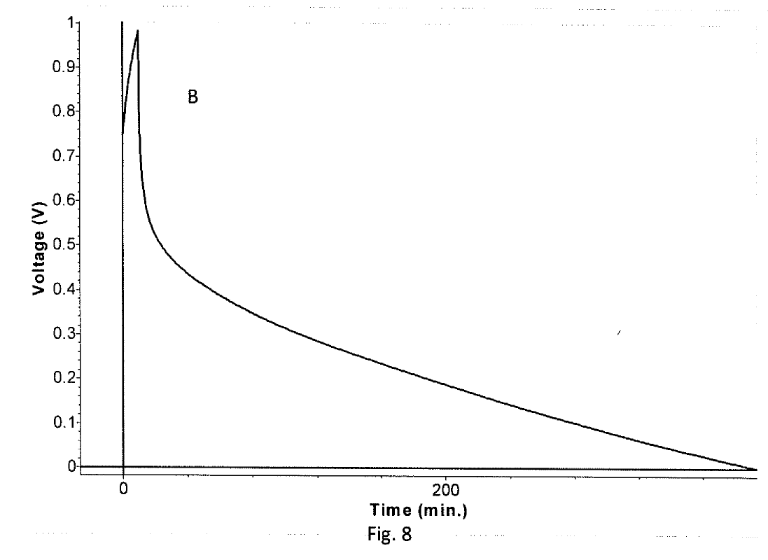

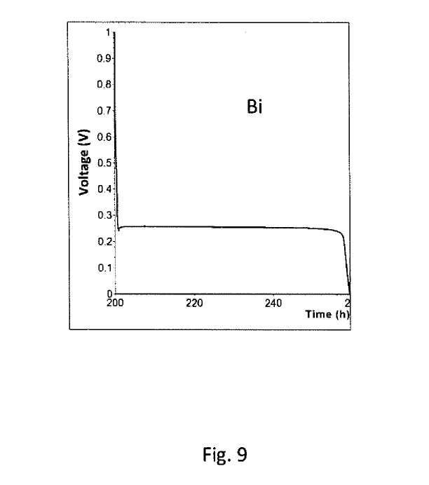

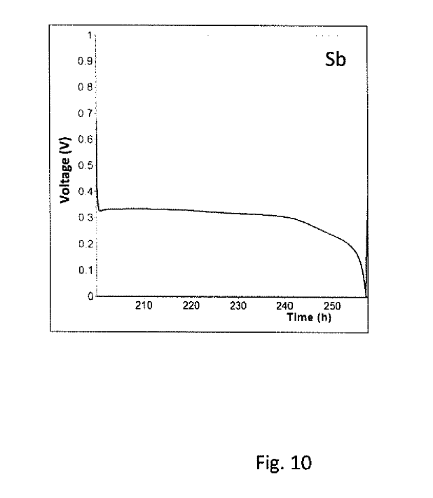

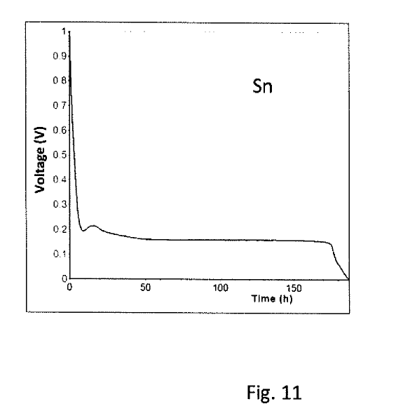

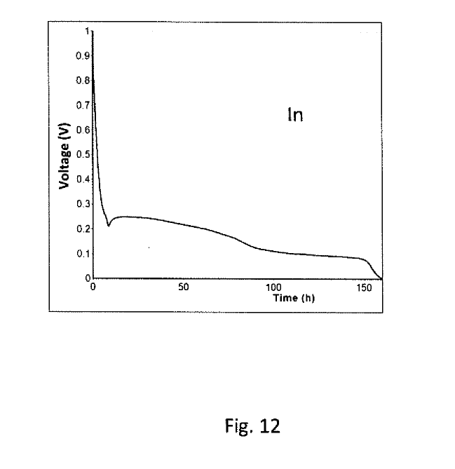

Referring to FIGS. 1-12 there are shown voltage plots of various materials according to the above recited formula. As can been seen by the plots, when a current is applied to the materials there is a change in the voltage as a function of time. This behavior indicates magnesiation of the material or insertion of Mg²⁺ ions into the material.

### Examples

The materials as disclosed in FIGS. 1-12 were deposited onto conductive substrate materials such as Cu foil. The plots of the various materials change as a function of time indicating magnesiation or insertion of Mg²⁺ ions into the materials.

Indium (In)

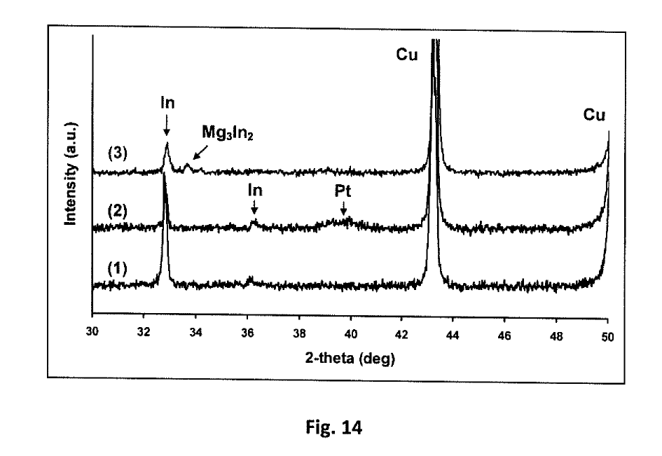

Referring to FIG. 14, In and magnesiated films of In were characterized via XRD to determine crystallinity, preferred orientation and the presence of any impurity phases. As seen in FIG. 14, the XRD spectra for In films on both Cu and Pt coated Cu substrates show a preferred (101) orientation (2-theta=32.8 deg.) along with the absence of any impurity phases (oxides and alloys). Further, upon magnesiation, crystalline peaks associated with the formation of magnesiated indium (Mg₃In₂) are observed along with a lowering in the crystallinity of the In peaks demonstrating the insertion of Mg²⁺ ions into the Indium material.

Tin (Sn)

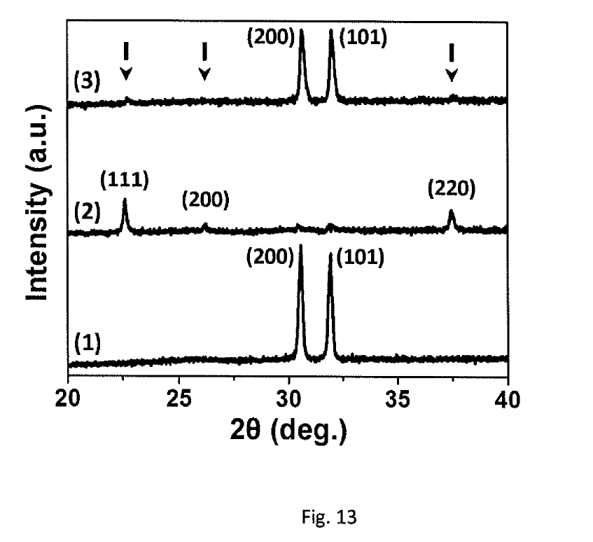

Referring to FIG. 13, Sn and magnesiated films of Sn were characterized via XRD. As seen in the figure, upon magnesiation, crystalline peaks associated with the formation of magnesiated tin (Mg₂Sn) are observed along with a lowering in the crystallinity of the Sn peaks demonstrating the insertion of Mg²⁺ ions into the tin material.

In one aspect, the present invention provides anode materials for magnesium ion batteries and also provides a method of identifying anode active materials for a magnesium ion battery that allow insertion of magnesium ions.

Presented below in Table 1 is a summary of the capacity, energy-density and voltage calculations for various materials. The voltage may be calculated according to the following equation: V=−(G_{MgxA}−G_{A}, pure−xG_{Mg,pure})/2x wherein G_{MgxA} is the free energy of compound MgₓA formed with Mg as the selected material A, G_{A},pure is the free energy of selected material A in the pure phase, and G_{Mg,pure} is the free energy of Mg in the pure phase.

TABLE 1

| | | capacity | energy density |
|---|---|---|---|
| materials | voltage (V) | (mAh/g) | (Wh/g) |
| Tl | 0.03393 | 262.3977 | 0.77829 |
| Eu | 0.082 | 352.1624 | 1.02761 |
| Bi | 0.1868 | 384.1782 | 1.08077 |
| Be | 0.052 | 457.5102 | 1.34874 |
| Hg | 0.1817 | 532.6261 | 1.5011 |
| Pb | 0.0324 | 517.189 | 1.53481 |
| Sb | 0.344 | 658.1438 | 1.74803 |
| Yb | 0.0795 | 618.8324 | 1.8073 |
| Ho | 0.0495 | 648.8358 | 1.91439 |
| Zn | 0.1405 | 691.7573 | 1.97808 |
| Pt | 0.42014 | 823.5214 | 2.12457 |
| Au | 0.29677 | 815.1619 | 2.20357 |
| Ru | 0.1352 | 794.9839 | 2.27747 |
| Sn | 0.15 | 899.6456 | 2.56399 |
| Dy | 0.05 | 985.1932 | 2.90632 |
| Tb | 0.0567 | 1009.979 | 2.97267 |
| Gd | 0.0613 | 1022.843 | 3.00583 |
| Sm | 0.0733 | 1070.578 | 3.13326 |
| In | 0.07396 | 1163.672 | 3.40495 |
| Ce | 0.0197 | 1147.049 | 3.41855 |
| Ir | 0.14864 | 1207.189 | 3.44213 |
| Sc | 0.029 | 1189.532 | 3.5341 |
| Ge | 0.2246 | 1466.545 | 4.07025 |
| Pd | 0.31116 | 1514.969 | 4.07351 |
| Cd | 0.06636 | 1433.809 | 4.20628 |
| Rh | 0.25635 | 1560.607 | 4.28176 |
| Tm | 0.0211 | 1520.346 | 4.52896 |
| Ag | 0.11787 | 1574.395 | 4.53761 |
| Er | 0.0242 | 1538.554 | 4.57843 |
| Cu | 0.10448 | 1685.949 | 4.8817 |
| Ni | 0.15698 | 1814.539 | 5.15877 |
| Ga | 0.1 | 1911.745 | 5.54406 |
| B | 0.2256 | 2433.131 | 6.75048 |
| Ca | 0.091 | 2676.446 | 7.78578 |
| Al | 0.0715 | 2808.615 | 8.22503 |
| Y | 0.0527 | 2886.951 | 8.50871 |
| Ba | 0.0528 | 3321.135 | 9.78805 |
| Si | 0.138 | 3823.491 | 10.94283 |
| Nd | 0.0233 | 4460.742 | 13.27829 |
| Pr | 0.026 | 4555.649 | 13.5485 |
| La | 0.05724 | 4621.199 | 13.59908 |
| Sr | 0.085 | 5170.405 | 15.07173 |

As shown from the data in Table 1, materials within the area of interest have voltages higher than the deposition voltage of magnesium for potential use as insertion-type anodes in a magnesium ion battery. As demonstrated from the examples presented above, materials having the desired properties provide insertion-type anodes that display insertion of magnesium ions.

The invention is not restricted to the illustrative examples described above. Examples described are not intended to limit the scope of the invention. Changes therein, other combinations of elements, and other uses will occur to those skilled in the art. The scope of the invention is defined by the scope of the claims.

Having described our invention, We claim:

1. A compound of the formula: A_{b}MgₐX₁₋ₐ (0≦a<1, 0≦b≦0.1) for use as an anode material in a magnesium ion battery wherein X is selected from one or more of: group 15 elements, group 14 elements, group 13 elements, transition metals from groups 3-12 and lanthanides.

2. The compound of claim 1 wherein X includes compounds or alloys having the formula:
Z′_{c}Z″_{1-c} (0<c<1) wherein Z′ and Z″ are selected from group 15 elements, group 14 elements, group 13 elements, transition metals from groups 3-12 and lanthanides.

3. The compound of claim 1 wherein the working voltage of the compound is greater than the voltage of deposition of magnesium.

4. An anode for a magnesium ion battery, the anode comprising a compound of the formula:
A_{b}MgₐX₁₋ₐ (0≦a<1, 0≦b≦0.1) wherein X is selected from one or more of: group 15 elements, group 14 elements, group 13 elements, transition metals from groups 3-12 and lanthanides.

5. The anode of claim 4 wherein X includes compounds or alloys having the formula: Z′_{c}Z″_{1-c} (0<c<1) wherein Z′ and Z″ are selected from group 15 elements, group 14 elements, group 13 elements, transition metals from groups 3-12 and lanthanides.

6. The anode of claim 4 wherein the working voltage of the compound is greater than the voltage of deposition of magnesium.

7. An energy-storage device comprising:
a first electrode including an active material;
a second electrode;
an electrolyte disposed between the first electrode and the second electrode, the electrolyte including a magnesium compound, the active material including. a compound of the formula:
A_{b}MgₐX₁₋ₐ (0≦a<1, 0≦b≦0.1) wherein X is selected from one or more of: group 15 elements, group 14 elements, group 13 elements, transition metals from groups 3-12 and lanthanides.

8. The energy-storage device of claim 7, wherein the first electrode is a negative electrode, and the second electrode is a positive electrode.

9. The energy-storage device of claim 8, wherein the second electrode includes a cathode active material which shows electrochemical reaction at higher electrode potential than the first electrode.

10. The energy-storage device of claim 7 wherein Mg²⁺ ions are inserted into the first electrode active material.

11. The energy-storage device of claim 7 wherein X includes compounds or alloys having the formula: Z′_{c}Z″_{1-c} (0<c<1) wherein Z′ and Z″ are selected from group 15 elements, group 14 elements, group 13 elements, transition metals from groups 3-12 and lanthanides.

12. The energy storage device of claim 7 wherein the working voltage of the compound is greater than the voltage of deposition of magnesium.
